(19) United States
(12) Patent Application Publication
(10) Pub. No.: US 2016/0260007 A1
(43) Pub. Date: Sep. 8, 2016

(54) ULTRASONIC THIN FILM TAGS

(71) Applicant: EMPIRE TECHNOLOGY DEVELOPMENT LLC, Wilmington, DE (US)

(72) Inventors: Benjamin Watson BARNES, Thornleigh, New South Wales (AU); Michael Keoni MANION, Seattle, WA (US); George Charles PEPPOU, Hornsby Heights, New South Wales (AU); Benjamin William MILLAR, Rosebery, New South Wales (AU); Benjamin Matthew AUSTIN, Bangor, New South Wales (AU)

(73) Assignee: EMPIRE TECHNOLOGY DEVELOPMENT LLC, Wilmington, DE (US)

(21) Appl. No.: 15/031,188

(22) PCT Filed: Oct. 22, 2013
(86) PCT No.: PCT/US2013/066208

§ 371 Date: Apr. 21, 2016

(51) Int. Cl. G06K 19/077; G06K 7/02; G06K 19/06

(52) U.S. Cl. CPC G06K 19/07749; G06K 19/06037; G06K 19/06018; G06K 7/02

(57) ABSTRACT

Ultrasound thin film tags are disclosed. The tags include a pattern of regions, wherein the pattern is configured to create thin film interference when scanned with ultrasound energy. The tags can be placed in various locations within the article including interior surfaces and they can be used to encode a variety of information about the article. Devices and methods for scanning and decoding the tags are also disclosed.

### BACKGROUND

A variety of technologies exist for tagging or marking products for identification and tracking purposes. Technologies that are currently in use can be expensive and fragile. Surface markings such as barcodes or text are easily destroyed or damaged. While technologies currently exist for incorporating identification information inside the product, such interior markings incorporate electronic components that are costly and difficult to integrate into the product without interfering with the functioning of the product.

### SUMMARY

In one embodiment, a tag includes a pattern of regions, wherein the pattern is configured to create thin film interference when scanned with ultrasound energy. In some embodiments, the regions are raised or lowered relative to a surface.

In one embodiment, a device includes a tag, wherein the tag includes a pattern of regions, and wherein the pattern is configured to create thin film interference when the device is scanned with ultrasound energy.

In one embodiment, a method of tagging a device with a unique identifier includes: forming a tag within the device, wherein the tag includes a pattern of regions, wherein the pattern is configured to create thin film interference when the device is scanned with ultrasound energy.

In one embodiment, a method of deriving information from a tagged article includes: providing an article comprising a tag associated with a surface of the article, wherein the tag includes a pattern of regions that encode information related to the article, wherein the pattern is configured to create thin film interference when scanned with ultrasound energy comprising a directional stimulus signal; providing an ultrasound scanner configured to generate ultrasound energy comprising a directional stimulus signal; scanning the surface of the article with the ultrasound energy; detecting the thin film interference created by reflection of at least a portion of the directional stimulus signal that reflects from the pattern; and decoding the information related to the article from the thin film interference.

In one embodiment, an ultrasound scanner for deriving information from an article comprising a tag, includes: an ultrasound transducer module configured to generate a directional stimulus signal relative to the tag; a receiver module configured to detect thin film interference from a portion of the directional stimulus signal reflected from the tag; and a processor module configured to generate the directional stimulus signal, detect the thin film interference, and reconstruct from the thin film interference a pattern comprising the information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an embodiment of a tag on a device.

FIGS. 2A and 2B illustrate a cross-sectional view of embodiments of a tag on a surface or embedded into a surface.

FIG. 3 illustrates an embodiment of a pattern that creates thin film interference when scanned with ultrasound energy.

FIGS. 4A and 4B illustrate embodiments of a scanner used to read the tag embedded in a device.

FIG. 5 illustrates an embodiment of an image produced by moving the scanner across the surface of the device.

FIG. 6 is a flowchart depicting an illustrative process of reading a tag in an article.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Certain tag embodiments disclosed herein incorporate unique identification tags into a product. The tags, when incorporated in the interior of the product, may not interfere with the functioning of the product. The tags used in certain embodiments disclosed herein can be located within the product interior. As the tags reside in the product interior, they can therefore be used throughout the lifetime of the product without being damaged by external environment conditions. Furthermore, the internal tag can be more difficult to destroy than a tag on the surface of the product. Additionally, the internal placement can allow for the use of tags of different sizes or forms. Certain tag embodiments disclosed herein coupled with thin film interference technology can provide a unique identification marker which can be read or scanned using ultrasound energy or other acoustic waves.

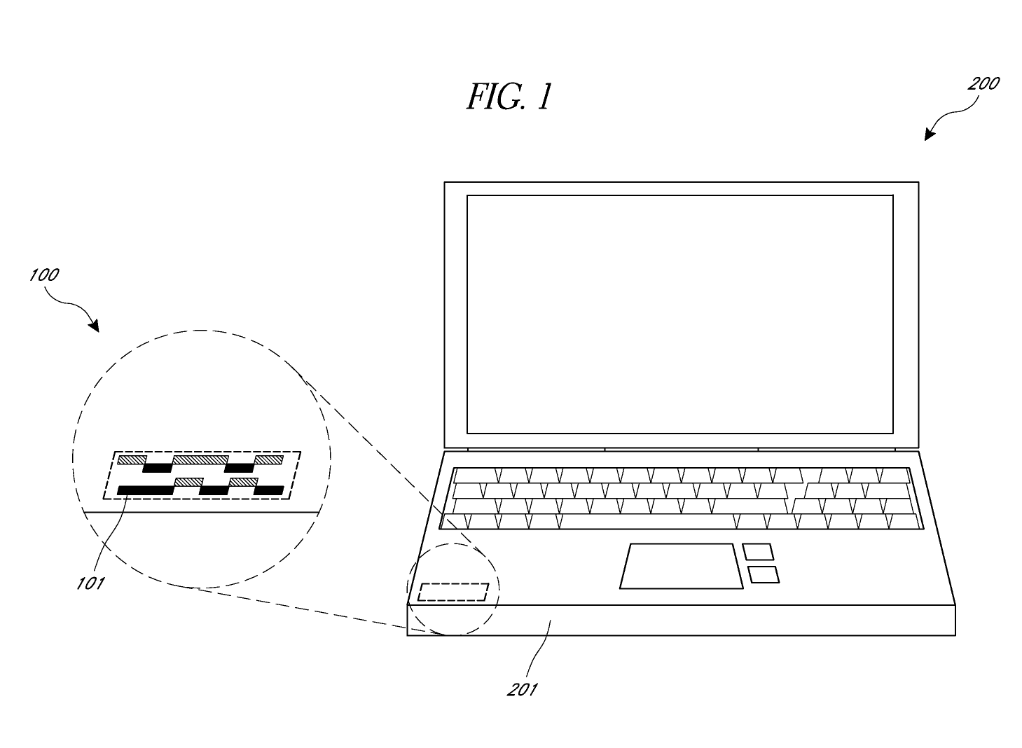

FIG. 1 illustrates an embodiment of a tag 100. The tag 100 can be on an interior surface of an article or device 200. In some embodiments, as illustrated in FIG. 1, the tag 100 may be incorporated into the article 200, for example, the tag can be integrated within the interior surface of the material used to make the exterior surface 201 of the article 200. In some embodiments, the tag 100 can have a pattern 101 created by regions that are raised and/or lowered relative to the exterior surface 201 of the article 200. The expanded view of the tag 100 in FIG. 1 illustrates an embodiment of the interior surface of the article 200 with a pattern 101 integrated on the interior surface.

The tag can be placed inside the article at a position that cannot be seen from the exterior of the article. For example, the tag can be placed on an interior surface of the article or embedded within the material forming a surface of the article. Additionally, in some embodiments, the tag can be read by a scanning device from the exterior of the article. In some embodiments, the tag can reside within the article so that modification or removal of the tag cannot be achieved without significantly damaging or disassembling the article. Such a placement of the tag can protect against vandalism, removal, or altering of the tag. Additionally, the internal placement of the tag allows for the tag to be incorporated into the article in such a way that the tag can reside in the article throughout the lifetime of the article while not affecting the form or function of the article. In some embodiments, a tag can be embossed into an interior surface of an article.

In some embodiments, a tag can be formed into an interior surface of an article. In some embodiments, the tag can be embedded within the material forming a wall or a surface of the article. In some embodiments, the material of the product surface can be suitable for embedding the tag into the surface material of the article. The surface of the article can be made of a material including a thermoplastic material, thermoset polymer, ceramic, or a composite of these.

In some embodiments, the tag pattern can be embossed into the surface through a process of hot embossing, cold deforming, or other suitable method known in the art and/or described herein for incorporating the tag into the article. In certain embodiments, cold deformation may be possible or desirable depending on the materials of the surface and/or the tag. Such low temperature embedding techniques can be necessary for materials that cannot withstand the heat embossing methods.

### Unique Identification Tag

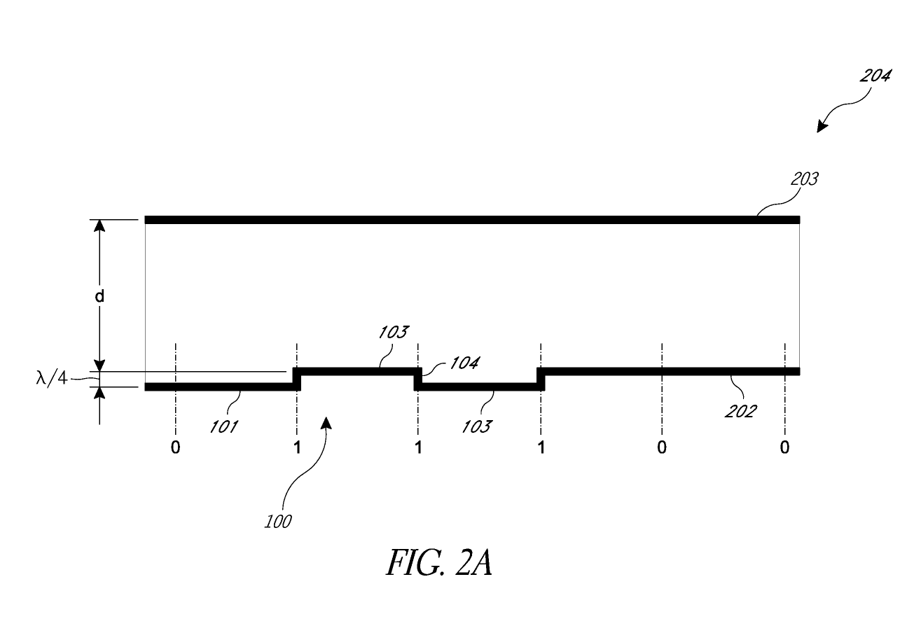

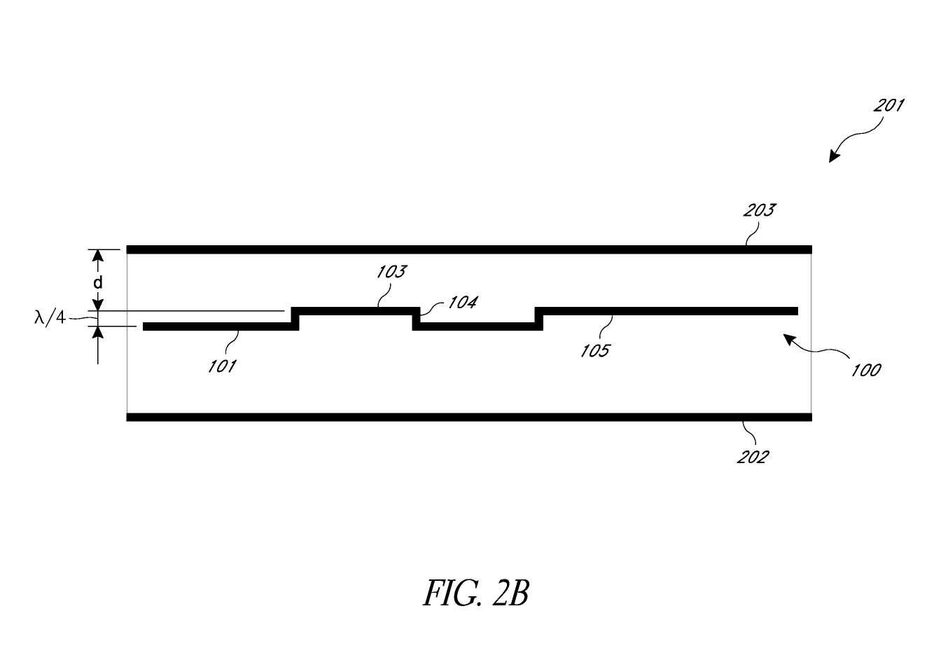

FIGS. 2A-B illustrate a cross-sectional view of embodiments of a tag on a surface or embedded into a surface. FIG. 2A illustrates an embodiment of the tag 100 integrated into the interior surface of an article. As shown in FIG. 2A, in some embodiments, the surface 204 of the article can have an exterior surface 203 and an interior surface 202. In some embodiments, the tag 100 can be integrated into the material of the interior surface 202. In some embodiments, the tag 100 can have a pattern 101 formed by regions that can be raised and/or lowered relative to the surface 202. The raised and/or lowered regions can have substantially horizontal and vertical surfaces 103, 104 as shown in FIG. 2A-B. In some embodiments, the substantially horizontal surface 103 of a raised region can have a distance from the exterior surface 203 to the horizontal surface 103 of the raised region which is smaller than the distance between the horizontal surface 103 of a lowered region and the exterior surface 203. The approximate feature size is measured as the difference between the distance from the exterior surface 203 to the horizontal surface 103 of the raised region and the distance between the horizontal surface 103 of a lowered region and the exterior surface 203. The minimum feature size (corresponding to the highest data density) supported by the tag can depend on several parameters including: the wavelength of the sound used, the thickness of the material, the rate at which sound diffuses through the material, and loss. The feature size can be greater than or equal to about 0.1 mm, or less than or equal to about 2 mm. In certain embodiments, the feature size can be about 0.1, 0.2, 0.4, 0.6, 0.8, 1.0, 1.2, 1.4, 1.6, 1.8, 2.0 mm. In some embodiments, it is possible to resolve feature sizes smaller than 0.1 by using sound frequencies in the 0.1-10 GHz range.

The thickness of the raised portions can be dependent on the frequency used to read the tag. In some embodiments, the thickness of the raised and lowered regions can be selected to minimize noise from similarly sized structures on the printed surface. The frequency chosen to read the tag can depend on the quantity of data to be printed and/or the available area on which to print it. For example, if a large amount of data is to be placed on a small area, then small raised and lowered features must be used, thus requiring a higher reading frequency to resolve them.

The overall size of the tag and its raised portions can be determined by existing characteristics of the object into which they are included, the quantity of data to be written, and the method of reading. In some embodiments, the overall size can be constrained by the available area and can be filled with raised features as large or as small as required. In some embodiments, the aspect ratio or the length and width of the raised regions can be a design choice. If there is little data to print, then they may be written as high aspect ratio bars similar to a bar code for ease of reading. They may also be printed as shortened versions of these bars if desired. In some embodiments, the length and width of raised regions can be an arbitrary choice.

In some embodiments, the pattern 101 of the tag 100 can be hot embossed onto the surface 204. The surface 204 can be a casing of the product or article. In some embodiments, the tag 100 can be embossed onto the interior surface 202 as shown in FIG. 2A. For example, in some embodiments, the casing can be made of a thermoplastic material and the pattern can be hot embossed into that thermoplastic material. In some embodiments, it may be desirable for the pattern to be cold deformed into the surface of the product or article depending on the materials of the surface. Additionally, in some embodiments, the tag 100 can be a pattern formed into a plate which can be inserted or embedded within a material of the article casing or surface. As shown in FIG. 2B, the tag can be embedded within the material of a surface 201 of the article, between the exterior surface 203 and the interior surface 202.

In some embodiments, the tag includes patterns configured to create thin film interference when scanned with an acoustic wave, for example, ultrasound energy. In such embodiments, the patterns may encode identification data or other information regarding the article as described in detail herein. An image may be derived from the thin film interference. The image can encode data or other information regarding the article being scanned. The encoded data can contain information relating to a unique identifier (such as a UPC), details of material characteristics, product origin, manufacture and/or any other information regarding the article that may be necessary or useful for identification or tracking of the article. The density of the data encoded in the tags is not particularly limiting. The encoded data may in certain embodiments include a density of greater than or equal to about 1 bit/cm², or less than or equal to about 100 bits/cm². In certain embodiments, the data density may be about 1, 5, 10, 15, 20, 25, 30, 35, 40, 45, 50, 55, 60, 65, 70, 75, 80, 85, 90, 95 or 100 bits/cm². In some embodiments, the data density of the tags can be less than 1 bit/cm², for example, tags of less than 1 bit/cm² would be reasonable for large industrial applications.

FIG. 2B illustrates a cross-sectional view of an embodiment of a tag embedded into an article. FIG. 2B illustrates an embodiment similar to the embodiment described with reference to FIG. 2A, however, the embodiment of FIG. 2B contains a tag that has been embedded into the material of the article wall below the surface 201 rather than embossed onto the surface of the article. In some embodiments, the tag 100 can be produced by stamping the pattern 101 onto a plate 105, with raised and/or lowered regions similar to those described with reference to FIG. 2A. The plate 105 can be embedded into the material of the wall below the surface 201, as shown in FIG. 2B. The pattern 101 on the embedded plate 105 can create thin film interference when scanned with ultrasound energy and thereby provide the encoded data or information of the tag 100 through the same methods and procedures described with reference to FIG. 2A and as further described and disclosed herein. In some embodiments, the plate can be embedded into the wall below the surface 201 during manufacture. Methods of embedding the tag within the material can be used for application to composite materials including carbon-fiber-reinforced polymers (CFRPs). The material used for the plate is not particularly limiting. In some embodiments, the plate is made of metal, thermoplastics, thermoset polymer, and ceramic or a composite of these.

In some embodiments, other than forming raised and lowered regions, the pattern 101 can be formed by a change in density, a change in rigidity or both along the tag. A variation in density or rigidity can be used to incorporate the pattern into the device or article. There is not necessarily a need for raised or lowered regions in some embodiments as the regions of different density and/or rigidity produce the same effect on incoming ultrasound signals or other acoustic waves. For example, any method that creates a significant change in rigidity and/or density of a material can be used to incorporate the pattern, such as laser writing, thermal modification, selective copolymerization, and/or any other method known in the art.

The pattern of the tag can be one-dimensional or two-dimensional. For example the two-dimensional pattern can form square regions, rectangular regions, or both. In some embodiments, the pattern can form an image that represents a logo and/or other indicia. Additionally, in some embodiments, the pattern 101 is a repeating pattern. In some embodiments, the repeating pattern can repeat across the surface of the entire product. Such repetition of the pattern can be helpful in the event that the product is damaged and/or has been disassembled. The tag can still be readable even with such alteration to the article. Further, in some embodiments, the internal placement of the tag allows the tag to be present within the article without impacting the user experience as the user may not be aware of the presence of the tag.

Identification of a Tag within the Device

The tag can be associated with a device as illustrated in FIG. 1. The tag can be a pattern of regions that are raised and lowered relative to a surface. The pattern can create thin film interference when scanned with ultrasound energy or other acoustic waves. The device 200 can have a surface 201. The surface 201 can be a casing, and the casing, for example, can be a thermoplastic material. In some embodiments, the casing can have a thickness of 10 mm or less. For example, the pattern can be hot embossed into the interior surface of the thermoplastic material of the device as described herein. Additionally, the tag can be a pattern formed on a plate as described herein. The plate can be embedded within the casing of the device.

In some embodiments, the distance between an exterior surface of the device and the pattern is approximately constant over a length of the tag. This approximately constant distance can allow for proper interpretation and decoding of the data received by a scanner. Although the type of device or article that can include the acoustic wave readable tags is not particularly limiting, some examples of devices in which such tags could be desirable include consumer electronics, for example desktop or laptop computers, electronic tablets, PDA's, MP3 players, and cellular phones. The tag can be used for identification and tracking of these products. A scanning device utilizing an acoustic wave, such as ultrasound waves, can direct the acoustic wave into the tagged region of the product and decode the received signal, thereby allowing for identification of the unique marking or tag, as detailed below.

### Scanning Using Thin Film Interference

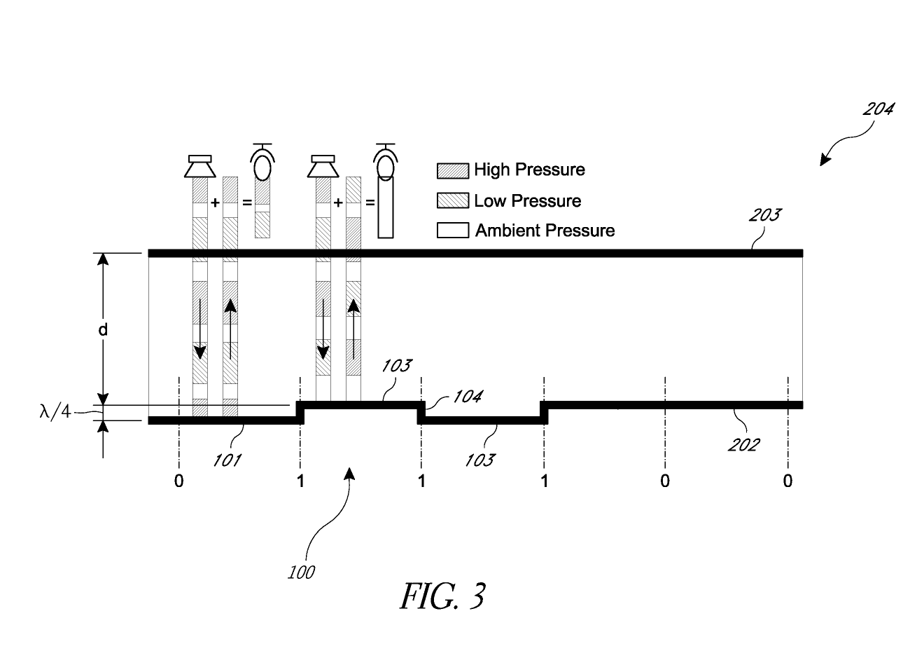

In some embodiments, controlled thin film interference created by scanning an embedded tag is used to decode the identification data or other information regarding the article as described in detail herein. Thin film interference can occur with any traveling wave that is subject to changes in material impedance. In some embodiments, an acoustic wave, for example ultrasound energy, can be transmitted into the article surface 204 as shown in FIG. 3. The acoustic wave can be subjected to acoustic impedance of the transmission medium and the manipulation of the acoustic path length can be detected to determine the pattern on the tag. For example, the wave is presented with two propagation paths of different lengths that end at the same location. This allows the wave to be split and recombined, which in turn allows the wave to interfere with itself upon recombination. If the difference in path lengths includes a half wavelength (for example, 0.5λ, 3.5λ) the wave will recombine 180° out of phase, and destructively interfere, cancelling out to zero. Alternatively, if the difference in path lengths is an integer multiple of the wavelength, the wave will constructively interfere upon recombination, producing a resultant wave that has the same amplitude as the source (assuming losses are ignored). In some embodiments, the large acoustic impedance mismatch between the material comprising the surface of the article and air can be used to provide a reflective interface.

With minimal loss, if the feature size is equal to a quarter of the wavelength of the acoustic wave being reflected, the path length includes a half wavelength that can be about 0.5λ, 1.5λ, 2.5λ, 3.5λ, 4.5λ, which will recombine 180 degrees out of phase, and destructively interfere. FIG. 3 illustrates a cross-sectional view of an embodiment of a pattern within an article that creates thin film interference when scanned with ultrasound energy or other acoustic waves. In some embodiments, the reflective surface can be provided by the large acoustic impedance mismatch between the thermoplastic casing and air. The exterior surface 203 of the article casing can be scanned with ultrasound energy. FIG. 3 illustrates a differential code used to store the data. If the wave travels along the λ/4 dimension twice, the resultant wave can have a net λ/2 path length difference. The code, as illustrated in FIG. 3, can represent a ‘1’ as a change in response, and a ‘0’ when there is no change. Therefore, as long as thickness ‘d’ is reasonably consistent over the length of the tag, the actual value of the distance becomes unimportant. In some embodiments, software compensation can be used to account for minor inconsistencies in the thickness, d, by ignoring slow measurement drift and only responding to sudden changes in amplitude.

The data density encoded by the tag can depend on various parameters. For example, the wavelength of the sound used, the thickness of the material (‘d’), and the rate at which sound diffuses through the material can affect the density of data that can be encoded by the tag. In some embodiments, the tag can be integrated into a thin material. The thickness of the material can be less than about 10 mm. Additionally, in some embodiments, the material can be rigid.

### Scanning Mechanism

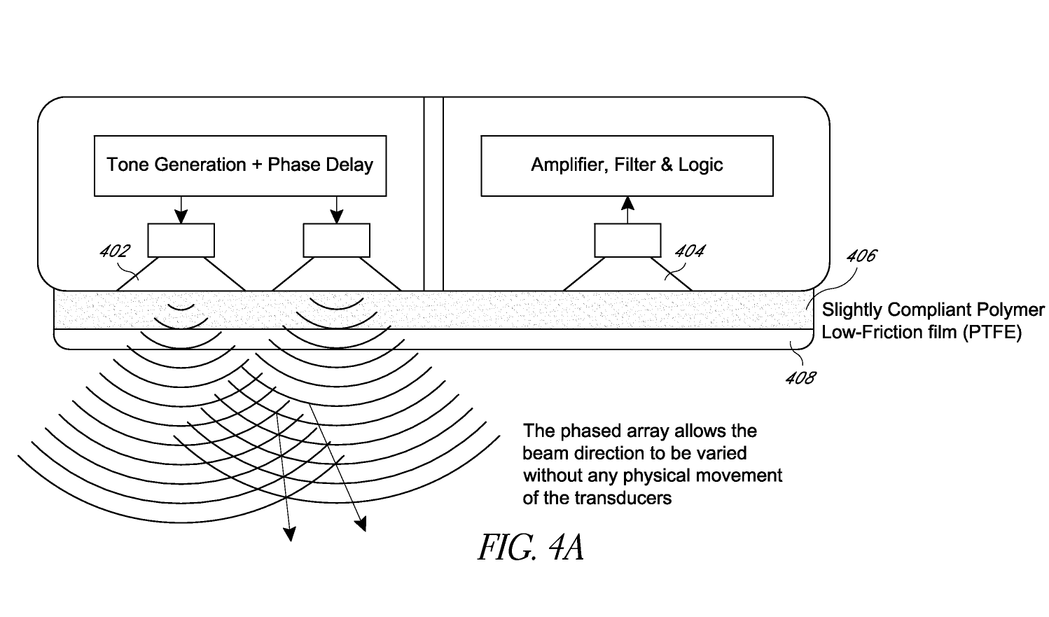

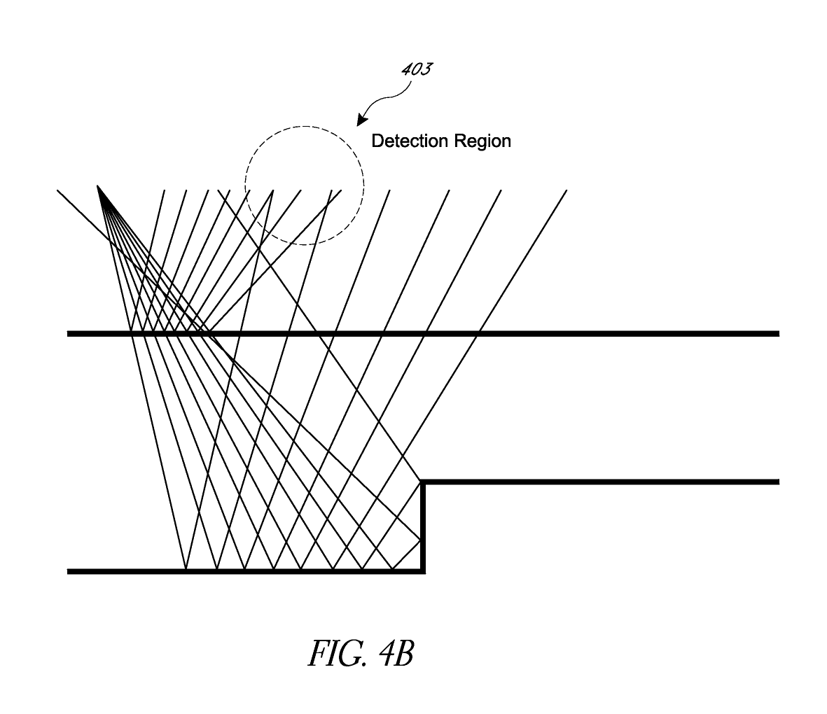

FIGS. 4A-B illustrate embodiments of a scanner that can be used to read a tag embedded in an article or device. In some embodiments, the scanner can have at least one transducer 402 and at least one receiver 404. In some embodiments, a polymer pad 406 can be placed between the outer surface of the article and the transducers 402 and receiver 404. In some embodiments, a film 408 can be placed on the outer surface of the device for contacting the surface of the device.

The at least one transducer 402 can create a directional stimulus signal that generates a thin film interference pattern when reflected from the tag. In some embodiments, a single transducer 402 can be angled to create a directional stimulus signal. In other embodiments, two or more transducers 402 can be used to generate a directional stimulus signal, as illustrated in FIG. 4A. In some embodiments, the directional stimulus can be a phased array of two or more ultrasound transducers. In some embodiments, the at least one ultrasound transducer can have a tone generation module. For example the tone generation module can create a phased array capable of producing a directional stimulus signal with an arbitrary waveform. In some embodiments, the tone generation module can have a signal synthesizer that generates a signal, a filter stage, a delay unit, and/or any other component necessary for creating a transmitter known in the art and/or described herein. The signal synthesizer can have a variable oscillator, an additive synthesizer, a wavetable synthesizer, and/or any other method of signal synthesis known in the art and/or described herein. In some embodiments, the tone generation module can have a filter stage that incorporates high-, low- , or band-pass, notch or all-pass filters. A delay unit can introduce a phase shift between the transducers. Additionally, a set of amplifiers can be used to couple the signal to the transducers. Acoustic coupling may also be used in certain embodiments. The components of the tone generation module can be adapted from existing ultrasound imaging equipment known in the art and used for both medical and engineering purposes. In some embodiments, the phased array allows the beam direction to be varied without any physical movement of the transducers. The beam direction can be varied by changing the phased relationship between transducers.

In some embodiments, the scanner has a receiver 404. The receiver can be adjacent to the surface of the device. The receiver 404 can be used to detect a reflected portion of the directional stimulus signal. The directional stimulus signal produced by the transducers is reflected from a substantially horizontal surface toward the receiver 404. By controlling the placement of the transducers and receiver in the scanner, the geometry of the tag may be detected. In some embodiments, the placement of the transducers and/or receivers is controlled to provide a higher effective resolution, as illustrated in FIG. 4B. A specified detection region 403 can be selected to control the reflected signals that are detected by the receiver. For example, as illustrated in FIG. 4B, if the next bit is different from the current bit (a 0-1 transition), the signal is reflected to the left of the detection region 403. Additionally, if the next bit is different from the current bit in a 1-0 transition, the signal will be reflected to the right of the detection region. This specified and controlled detection region can eliminate spurious readings that may result from signals being reflected from multiple features. In some embodiments, the receiver can amplify the reflected portion of the directional stimulus signal. In some embodiments, the receiver can filter the reflected portion of the directional stimulus signal.

Depending on the specific application of the scanner, the polymer pad 406 and/or film 408 can use used to improve the performance of the device. The polymer pad 408 can be used to enhance the acoustic coupling to a surface of the device. The polymer pad 408 can be a slightly compliant polymer, for example a polymer with a Young's modulus of about 0.05 GPa to about 2 GPa, preferably with a Young's modulus of about 0.08 GPa to about 1 GPa. In some embodiments, the film can be placed on the outer surface of the article. The film can be placed between the polymer pad and the outer surface. In some embodiments, the film can be a low friction film. The low friction film can be sufficient to create a static coefficient of friction between the device and the scanner of 0.2 or less (about 0.2 or less). In some embodiments, the film can be a polytetrafluoroethylene (PTFE) film. In some embodiments, the scanner can be used without the polymer pad and/or film.

In some embodiments, the scanner can also include a processor to correlate the reflected portion detected by the receiver with a dimension of the tag. The scanner can have a method of correlating the received amplitude data with a spatial dimension. Additionally, in some embodiments, the scanner can correctly resolve the sequence of multiple 1's and 0's without adding or dropping any. A variety of methods can be implemented to perform the processing functions. The method chosen can depend on the specific usage requirements of the scanner. In some embodiments, a MEMs accelerometer chip can be used to map the amplitude with respect to the location. Other accelerometer designs known in the art can be used for this purpose. In some embodiments, an optical distance tracker can be used to scan the tagged surface and record the movement.

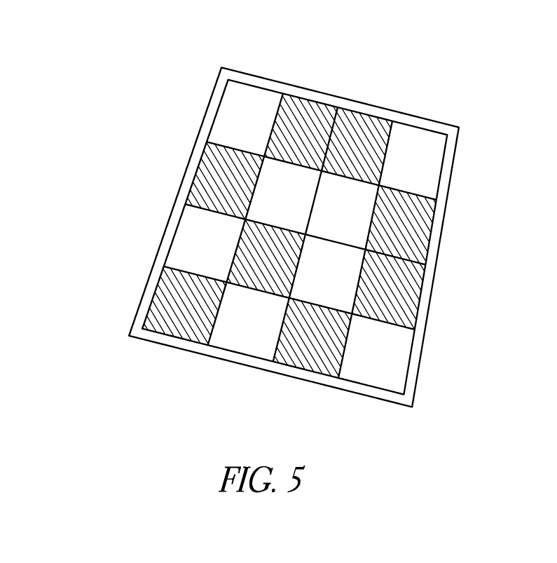

The correlation of the reflected signals and the dimensions of the tag can produce an image similar to the one illustrated in FIG. 5. The image can be produced by moving the scanner across the surface of the device. For example, in some embodiments, the optical distance tracker can scan the surface of the device and incorporated tag and record movements. In some embodiments, imaging software can be used to reconstruct the image from the reflected portion detected by the receiver. The image produced can correspond to the tag. In some embodiments, once the image of the tag is produced, the data can be decoded by simple computerized image recognition software. In some embodiments, the computerized image recognition software can decode data from the image without presenting the data as an image. In some embodiments, the recognition and data decoding can be steps that remain internal to the software used. In some embodiments, the software can take the amplitude vs. position reading from the tag, such as a 2 dimensional map or image and then the software can output the numerical data encoded into the tag. In some embodiments, it may not be necessary to create an image recognizable to the human eye, but a data capture that fits the definition of an image can be produced for decoding the two dimensional arrays, such as the repeating pattern across the surface. This can allow the software to orient the data, set boundaries, and read at an appropriate resolution. In other embodiments, if the tag were in the form of a barcode, rather than a two dimensional array, and the operator knew the exact position of the tag, the tag could be scanned as a barcode, with binary data delivered directly without the need for generating a data capture that fits the definition of an image.

The image can encode data or other information regarding the device. The encoded data can contain information relating to a unique identifier (such as a UPC), details of material characteristics, product origin, manufacture and/or any other information regarding the article that can be necessary or useful for identification or tracking of the article. As discussed above, data density is not particularly limiting, and generally ranges from about 1 bit/cm² to about 100 bits/cm². The data density can be dependent on several factors, for example if a high frequency source is used with a thin material, then data densities of greater than about 100 bits/cm² can be used. For example, with reference to Table 1, where the material is about 0.5 mm thick and the ultrasound frequency is 5 MHz, bit density may be as high as 10,000 bits/cm². Additionally, in some embodiments, the data density can be less than about 1 bit/cm², for example for use in industrial applications.

The bit density and feature size can be dependent on the ultrasound frequency and material thickness used in the system. Table 1 displays the approximate feature size and approximate bit density based on the material thickness and ultrasound frequency used.

TABLE 1
Theoretical estimates of discernible feature size and
corresponding bit density versus material thickness and
ultrasound frequency. These estimates assume a fixed
5:1 dispersion rate with no frequency dependence.

| | Ultrasound Frequency | | |
|---|---|---|---|
| Material Thickness | 50 kHz | 500 kHz | 5 MHz |

Approximate Feature Size vs. Frequency & Material Thickness

| | | | |
|---|---|---|---|
| 0.5 mm | 2 mm | 0.2 mm | 0.1 mm |
| 1 mm | 2 mm | 0.2 mm | 0.2 mm |
| 5 mm | 2 mm | 1 mm | 1 mm |
| 10 mm | 2 mm | 2 mm | 2 mm |

Approximate Bit Density (b/cm\hat{ }2) vs. Frequency & Material Thickness

| | | | |
|---|---|---|---|
| 0.5 mm | 25 | 2500 | 10000 |
| 1 mm | 25 | 2500 | 2500 |
| 5 mm | 25 | 100 | 100 |
| 10 mm | 25 | 25 | 25 |

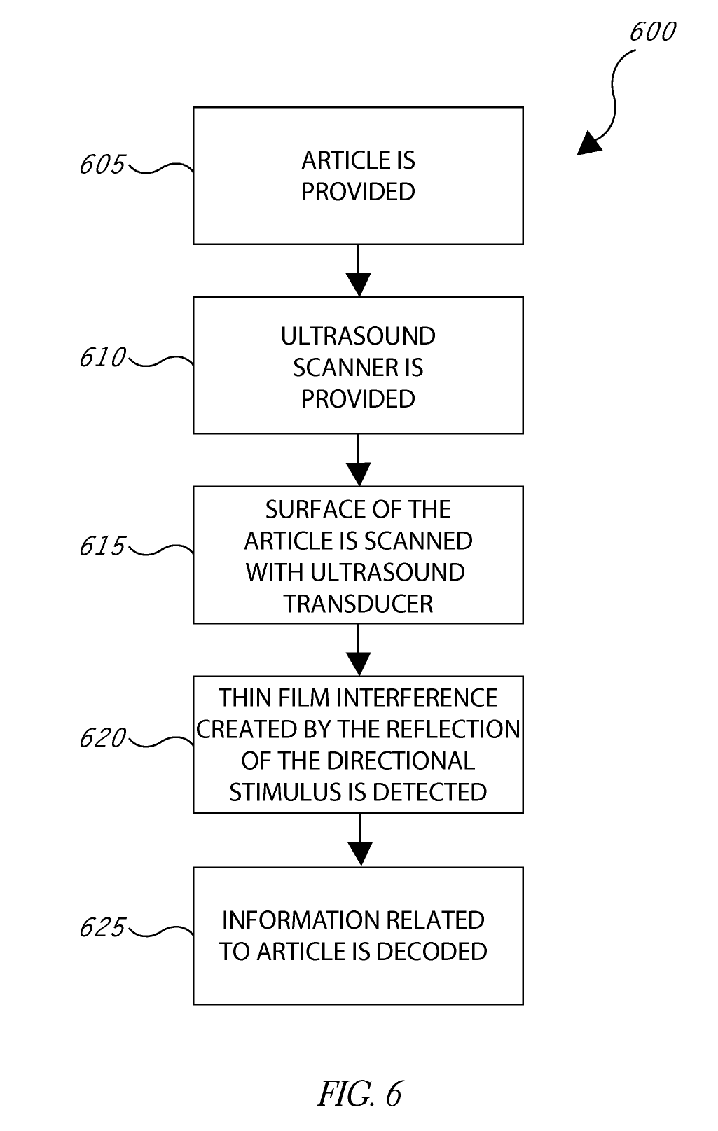

FIG. 6 is a flowchart depicting an illustrative process of scanning a tag in an article. The method of FIG. 6 can be performed by a person utilizing a scanner or a machine with a scanner integrated within. The scanning process 600 begins at block 605, where the article is provided. In some embodiments, the article can have a tag associated with a surface of the article. The tag can have a pattern of regions that encode information related to the article, and the pattern can create thin film interference when scanned with ultrasound energy with a directional stimulus signal. In some embodiments, the article can be provided by the user. The process 600 proceeds to block 610, where a scanning device is provided. In some embodiments, the scanning device is an ultrasound scanner that can generate ultrasound energy with a directional stimulus signal. The scanning device can have at least one phased array of one or more ultrasound transducers as described herein. For example, the one or more transducers can generate a directional stimulus signal.

At block 615, the scanning device can scan the surface of the article with the ultrasound energy. In some embodiments, the scanning region of the article is a portion of an exterior surface of the article. In some embodiments, the tag can underlie the portion of the exterior surface that is being scanned.

The scanning process 600 then proceeds to block 620. At block 620, the scanning device detects the thin film interference created by reflection of at least a portion of the directional stimulus signal that reflects from the pattern. In some embodiments, the receiver can then be used to detect the reflected portion of the directional stimulus signal. In some embodiments, the receiver of the scanning device can detect a portion of the directional stimulus signal that reflects from both the surface of the article and the underlying tag. At block 625, the scanning device can decode the information related to the article from the thin film interference. In some embodiments, the information can be decoded using image recognition software. In some embodiments, the image recognition software can base the method used to decode the data on image analysis techniques.

### EXAMPLES

### Example 1

### Hot Embossed Tag for Laptop Computer

A laptop computer can be tagged with a thin film interference tag by hot embossing a pattern into an inner surface of the laptop computer. The hot embossing process can create indentions or protrusions onto the thermoplastic material of the inside surface of the laptop computer. An additional step is added to the production of the thermoplastic casing. After molding, each casing is stamped with a heated press in a specified location on the interior face of the casing. Each casing may be given the same embossed stamp or an individual imprint may be assigned to each as a serial number. The stamp is heated to above the glass transition temperature of the thermoplastic, to allow embossing under moderate pressure.

This example shows that a pattern of raised and lowered regions can be readily created in the casing of a laptop by a process of hot embossing directly on a surface of the casing.

### Example 2

### Cold Deformed Tag for Laptop Computer

A laptop computer can be tagged with a thin film interference tag by cold deformation of a pattern into an inner surface of the laptop computer. The cold deformation process will create indentions or protrusions into a metallic material (for example, aluminium) of the surface of the laptop computer casing. The stamping process is similar to that used in hot embossing of thermoplastic resins, however significantly greater pressure (above the yield point of the ductile material) is used, and it may be performed at ambient temperature. This single step is added to the process of manufacturing, and it may be integrated into the primary stamping step for stamped metal products.

This example shows that a pattern of raised and lowered regions can be readily created in the casing of a laptop computer by a process of cold deformation directly on a surface of the casing.

### Example 3

### Stamped Plate Tag for Cellular Telephone

A cellular telephone can be tagged with a thin film interference tag by embedding within the casing a plate with a pattern stamped therein. A plate is stamped with raised and lowered regions that create a pattern. The stamped or preformed plate is embedded into the material of the article wall of the cell phone. The pattern utilizes thin film interference that is detected with a scanning device. The stamped embedded material can possess significantly different acoustic properties to that of the bulk material into which it is embedded. For a polymer phone casing, a metallic stamped plate is effective. This example shows that a pattern of raised and lowered regions can be readily included within the casing of a cellular telephone by a embedding a preformed plate having a thin film interference pattern stamped therein.

### Example 4

### Density Alteration of Tag for Laptop Computer with Laser Printer

A thin film interference tag can be incorporated in a casing of a laptop computer by creating regions of different densities using a laser printer. Laser printing onto the casing can created regions of different densities. The regions of different densities in the casing of the laptop computer create a pattern configured to create thin film interference when scanned with ultrasound energy. This laser printing process involves laser engraving the desired pattern into the casing of the laptop computer. This process removes material via thermal ablation, thus creating the pattern in the form of an array of pits, where the density varies from polymer surrounding the pits to air within the pits. It may also be possible to simply alter the density of the polymer by laser engraving at a sufficiently low power to not ablate, but simply expand or densify to produce the same effect. This is one additional step to manufacturing, in which each casing is passed through a laser engraving platform post forming.

This example shows that a pattern of regions of different density can be readily created in the casing of a laptop computer by a process of laser printing directly on a surface of the casing.

### Example 5

### Scanning a Tag Containing Encoded Data

A tag can be scanned with an ultrasound scanner to derive information encoded within the tag. The information can be encoded in the tag, and the tag can be embedded within a casing of an article. A polymer pad may be placed between the scanner and an outer surface of the casing to improve acoustic coupling of ultrasound energy from the scanner to the casing. The scanner has a pair of acoustic emitter and receiver, and includes an accelerometer to map the translational location of the scanner as it is being passed over an area of the casing material containing the tag. The transducer directs ultrasound energy in the form of a directional stimulus signal at an angle to the casing surface where the tag is. The ultrasound energy is then subjected to material impedance of the transmission medium (the casing with the tag) when in contact casing surface. The ultrasound energy is reflected from the casing surface and the reflected signal is detected by the receiver. The information encoded in the tag is reconstructed by processing the reflected signal and reconstructing the data pattern of the tag. Due to the specific dimensions imprinted on the casing material, the level of interference can be readily read as binary data, for example present, or destructively interfered. This binary data, matched with its corresponding translational map data from the accelerometer, can be simply compiled by arbitrary coordinates to form an image. This image may be processed by common decoding software, as used for QR code scanners.

This example shows that a pattern of information encoded on the casing of the article can be readily derived by a process of scanning a surface of the device with a directional stimulus signal.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

1. An article comprising:
an exterior surface;
an interior surface spaced from the exterior surface; and
a tag including a pattern of regions formed on the interior surface, the pattern of regions including:
at least one raised region extending from the interior surface and away from the exterior surface; and
at least one lowered region extending from the interior surface towards the exterior surface;
wherein the pattern of regions is configured to create thin film interference when scanned with ultrasound energy.

2. (canceled)

3. The article of claim 1, wherein the pattern of regions includes portions having different densities, different rigidities or both different densities and different rigidities.

4. The article of claim 1, wherein the pattern of regions encodes data derivable from the thin film interference.

5. The article of claim 4, wherein the data comprises an image related to the pattern of regions.

6. (canceled)

7. The article of claim 4, wherein the data comprises a density of greater than about 1 bit/cm².

8. The article of claim 4, wherein the data comprises a density of less than or equal to about 100 bits/cm².

9. The article of claim 4, wherein the data comprises a density of greater than about 100 bits/cm².

10. (canceled)

11. The article of claim 4, wherein the data comprises information related to at least one of:
a unique identifier;
a material characteristic;
a product origin; or
a manufacture lot or date or both.

12. The article of claim 1, wherein the pattern of regions is disposed on a plate, the plate including the interior surface.

13. The article of claim 12, wherein the plate is made of metal, thermoplastic, thermoset polymer, ceramic, or a composite of two or more of these.

14. The article of claim 1, wherein the pattern of regions is repeated.

15. The article of claim 1, wherein the pattern of regions is one-dimensional.

16. The article of claim 1, wherein the pattern of regions is two-dimensional.

17. The article of claim 16, wherein the two dimensional pattern of regions comprises square regions, rectangular regions, or both.

18.-23. (canceled)

24. The article of claim 12, wherein the plate is embedded within a casing.

25. The article of claim 1, wherein a distance between the exterior surface of the device and the interior surface is approximately constant over a length of the tag.

26. The article of claim 1, wherein the article forms at least a portion of a computer, an electronic tablet, a PDA, an MP3 player, or a cellular phone.

27. A method of tagging a device with a unique identifier, the method comprising:
providing the device including at least one article, the at least one article including,
an exterior surface; and
an interior surface spaced from the exterior surface; and
forming a tag on the interior surface of the at least one article, wherein the tag comprises a pattern of regions, the pattern of regions including:
at least one raised region extending from the interior surface and away from the exterior surface; and
at least one lowered region extending from the interior surface towards the exterior surface;
wherein the pattern of regions is configured to create thin film interference when the device is scanned with ultrasound energy.

28. The method of claim 27, wherein forming the tag comprises hot embossing or cold deforming the pattern of regions.

29. The method of claim 27, wherein forming the tag comprises stamping the pattern of regions into a plate; and embedding the plate within the device.

30. The method of claim 27, wherein forming the tag further comprises changing a density, a rigidity, or both, of a portion of a material layer in the device.

31. The method of claim 30, wherein changing the density, the rigidity, or both, is accomplished by laser writing, thermal modification, selective copolymerization, or a combination thereof.

32. The method of claim 27, wherein forming the tag includes forming the pattern of regions repeatedly within a portion of the device.

33. (canceled)

34. A method of deriving information from a tagged article, the method comprising:
providing at least one article including,
an exterior surface;
an interior surface spaced from the exterior surface; and
a tag including a pattern of regions that encode information related to the at least one article, the pattern of regions formed on the interior surface, the pattern of regions including:
at least one raised region extending from the interior surface and away from the exterior surface; and
at least one lowered region extending from the interior surface towards the exterior surface;
wherein the pattern is configured to create thin film interference when scanned with ultrasound energy comprising a directional stimulus signal;
providing an ultrasound scanner configured to generate ultrasound energy comprising a directional stimulus signal;
scanning the exterior surface of the at least one article with the ultrasound energy;
detecting the thin film interference created by reflection of at least a portion of the directional stimulus signal that reflects from the pattern; and
decoding the information related to the at least one article from the thin film interference.

35. The method of claim 34, further comprising producing an image of the pattern of regions from the detected thin film interference prior to decoding the information.

36. The method of claim 34, wherein the directional stimulus signal is generated by physically angling a single ultrasound transducer in the scanner.

37. The method of claim 34, wherein the directional stimulus signal is generated by a phased array of two or more ultrasound transducers.

38.-55. (canceled)

56. The article of claim 1, wherein each of the at least one raised region and the at least one lowered region extends a distance of nλ/4 from each other, wherein n is an integer and λ is the wavelength of the ultrasound energy used to scan the article.

57. The article of claim 1, wherein the thin film interference includes at least one of constructive or deconstructive interference.

58. The article of claim 1,wherein the at least one raised region is integrally formed with portions of the article thereabout

59. The method of claim 27, wherein forming a tag on the interior surface of the at least one article includes forming the at least one raised region and the at least one lowered to extend a distance of nλ/4 from each other, wherein n is an integer and λ is the wavelength of the ultrasound energy.

60. The method of claim 34, wherein each of the at least one raised region and the at least one lowered to extend a distance of nλ/4 from each other, wherein n is an integer and λ is a wavelength of the ultrasound energy.
